(19) United States
(12) Patent Application Publication
(10) Pub. No.: US 2008/0305351 A1
(43) Pub. Date: Dec. 11, 2008

(54) Method For Inhibiting the Crystallization of Boric Acid

(76) Inventor: David M. Schubert, Lone Tree, CO (US)

Correspondence Address: U.S. Borax Inc., 8051 E. Maplewood Avenue, Bldg. 4, Greenwood Village, CO, 80111, US

(21) Appl. No.: 10/593,936

(22) PCT Filed: Mar. 24, 2005
(86) PCT No.: PCT/US2005/009931

§ 371 Date: Aug. 20, 2008

Related U.S. Application Data
(60) Provisional application No. 60/556,818, filed on Mar. 24, 2004.
(60) Provisional application No. 60/661,452, filed on Mar. 13, 2005.

(51) Int. Cl. B32B 21/04; B05D 3/02; C09K 21/02

(52) U.S. Cl. 428/537.1; 427/384; 252/608; 252/607

(57) ABSTRACT

A method for inhibiting the crystallization of boric acid is provided. Boric acid is dissolved in water and a vitrifying agent, such as an amino alcohol or amino acid, to form an aqueous mixture which is then dried to form a vitreous boric acid-containing residue. This mixture, when applied to a surface and allowed to dry on the surface, forms a vitreous boric acid-containing coating which is readily adherent to the surface, or if allowed to penetrate into a porous substrate, deposits a vitreous boric acid-containing residue within the substrate upon drying. The vitreous boric acid-containing residue provides beneficial properties, including for example improved fire retardancy and biocidal protection, to a variety of materials such as cotton batting, cellulose, and wood and paper products and gypsum wallboard.

### BACKGROUND

1. Field of the Invention

This invention relates to compositions and methods for inhibiting the crystallization of boric acid and the formation of a vitreous boric acid-containing residue. The invention provides a method for treating an article or substrate to provide a vitreous boric acid-containing treatment or coating, in which the crystallization of boric acid is inhibited. The boric-acid containing residue is readily adherent to surfaces and provides improved fire retardancy and biocidal protection.

2. Related Prior Art

Boric acid powder is used as a fire retardant in mattresses, cotton batting, cellulose insulation, and related similar materials. See, for example, U.S. Pat. No. 4,430,765. In some cases cotton batting is sprayed with an oil and then dusted with boric acid powder. This method of applying boric acid has the disadvantage that the boric acid particles are not readily adherent to the fibers or surfaces of the article being protected. Cotton batting treated with boric acid can be dusty and there is significant boric loss in the treatment process resulting in uneven distribution and undesirably high boric acid requirements in order to meet the required fire tests.

Alkanolamine borates have long been used commercially in industrial fluids, including lubricants, cutting fluids and brake fluids. Concentrated polyborate solutions, disclosed by Anger, Canadian Patent No. 1082230, may be prepared by reacting boric acid with alcoholamine or aliphatic polyamine. Such polyborate solutions are useful as yarn moistening agents, metalworking agents, coolants, liquid cleaners, and disinfectants.

Ethanolamine-boric acid solutions containing 10% boron are used widely in agriculture. Ott described the preparation of polyborate solutions and disclosed their use as fertilizers, U.S. Pat. No. 4,332,609. Hammons et al., U.S. Pat. No. 5,928,672, disclosed the preparation of polyborate fertilizer compositions formed as a reaction product of a boric acid compound and one or more cyclic amines in aqueous solution.

### SUMMARY

In one aspect, the invention provides a method for inhibiting the crystallization of boric acid comprising the steps of dissolving a source of boric acid in water and a vitrifying agent selected from the group consisting of amino alcohols and amino acids to form an aqueous mixture and allowing the aqueous mixture to dry, thereby forming a vitreous boric acid-containing residue. The aqueous mixture can be applied to a surface of a substrate before it is allowed to dry, thereby forming a vitreous boric acid-containing residue on and/or in the substrate.

In another aspect, the invention provides a method for forming a vitreous boric acid-containing coating on a substrate comprising the steps of: (a) dissolving a source of boric acid in water and a vitrifying agent selected from the group consisting of amino alcohols and amino acids to form an aqueous mixture; (b) applying the aqueous mixture to the substrate to form a coating; and (c) allowing the coating to dry.

In another aspect, the invention provides a method for protecting a combustible material against fire comprising the steps of: (a) dissolving a source of boric acid in water and a vitrifying agent selected from the group consisting of amino alcohols and amino acids to form an aqueous mixture; (b) applying the aqueous mixture to a surface of the combustible material; and (c) allowing the aqueous mixture to dry such that a vitreous boric acid-containing residue is deposited on the surface of the combustible material and/or within the combustible material, thereby enhancing the fire retardant nature of the combustible material.

In another aspect, the invention provides a method for protecting wood or lignocellulosic-based products against decay and insect attack comprising the steps of: (a) dissolving a source of boric acid in water and a vitrifying agent selected from the group consisting of amino alcohols and amino acids to form an aqueous mixture; (b) applying the aqueous mixture to the wood or lignocellulosic-based product; and (c) allowing the aqueous mixture to penetrate into the wood or lignocellulosic-based product; and (d) allowing the aqueous mixture to dry within the substrate, depositing a vitreous boric acid-containing residue, thereby providing protection against decay and insect attack.

In another aspect, the invention provides an aqueous composition comprising boric acid, 2-amino-2-methyl-1-propanol and water wherein the mole ratio of 2-amino-2-methyl-1-propanol to boric acid is above about 0.25:1 and below about 1:1.

### BRIEF DESCRIPTION OF THE DRAWINGS

FIG. 1 is a three-component mixture diagram for the boric acid-AMP-water system showing the zone of crystallinity, zone of boric acid insolubility and zone of vitreous residue according to the invention.

FIG. 2 is a three-component mixture diagram for the boric acid-AMP-water system showing the experimental data points of Example 1.

### DETAILED DESCRIPTION

A source of boric acid is dissolved in water and a vitrifying agent to form an aqueous mixture. This mixture, when applied to a substrate and allowed to dry, forms a vitreous (i.e. non-crystalline), boric acid-containing residue in which boric acid is inhibited from crystallizing and which is readily adherent to surfaces. This coating provides various beneficial properties to the treated substrate, including fire retardancy and biocidal protection. As used herein, the term “vitreous” means non-crystalline.

This invention provides a method for applying a fire retardant treatment to combustible materials such as cotton batting, cellulose, and wood and paper products. It further provides a method for applying a biostatic protective layer or treatment to materials which are susceptible to insect attack or microbial growth, such as paper, wood products, or on the surfaces of gypsum wallboard.

According to the methods of the invention, a source of boric acid is dissolved in water and a vitrifying agent to form an aqueous mixture in which boric acid is inhibited from crystallizing when the aqueous mixture dries. This mixture is applied to the material to be treated, then allowed to dry. The drying process involves the removal of water from the aqueous mixture, while the other two components (boric acid and the vitrifying agent) form a vitreous residue. Drying may be done at room temperature or at elevated temperatures, such as up to 200° C. or higher. However, if the temperature is too low, evaporative removal of water becomes too slow and if the temperature is too high, such as above the pyrolysis temperature of the vitrifying agent, the boric acid-containing residue will breakdown. A range of physical effects can be achieved upon evaporation of the water, ranging from a hard plastic-like boric acid-containing material to a pourable boric acid-containing oil, depending on the vitrifying agent used.

Suitable sources of boric acid for use in the methods of this invention include orthoboric acid (represented as either B(OH)₃ or H₃BO₃), metaboric acid (HBO₂) and boric oxide (B₂O₃). Orthoboric acid is preferred due to its rapid solubility and commercial availability. The source of boric acid is dissolved in water and a vitrifying agent to produce a liquid composition.

Suitable vitrifying agents for use in the methods of this invention include amino alcohols and amino acids. Amino alcohols, also known as alcohol amines, include as a subset the saturated amino alcohols known as alkanolamines. Suitable amino alcohols for use in the methods of this invention include 2-amino-2-methyl-1-propanol (“AMP”), ethanolamines, such as diethanolamine and monoethanolamine, 5-amino-1-pentanol and tris(hydroxylmethyl)aminomethane (“TRIS”). Lysine is an example of a suitable amino acid. The choice of vitrifying agent determines the physical characteristics of the non-crystalline boric acid-containing residue which is formed upon drying. For example, aqueous mixtures of boric acid with AMP or TRIS upon drying can provide a vitreous solid glassy residue which is clear, hard and dry to the touch, whereas aqueous mixtures of boric acid with monoethanolamine, diethanolamine or 5-amino-1-pentanol dry to a non-crystalline fluid residue which is viscous and sticky.

The preferred vitrifying agent is 2-amino-2-methyl-1-propanol (“AMP”), due to its ability to form a clear, hard, dry vitreous residue, as well as its commercial availability and cost. AMP is sold as AMP-95, a composition containing 95% AMP and 5% water (commercially available from Argus Chemicals). In addition, AMP remains clear while some, other vitrifying agents tend to turn yellow. Yellowing could be disadvantageous in some applications such as for treating paper.

The relative concentrations of boric acid, the vitrifying agent and water in the aqueous mixture influence other important properties which can effect the usefulness of the aqueous mixture in the methods of this invention. For example, the viscosity of the aqueous mixture increases as the amount of water decreases (i.e. as the concentrations of boric acid and the vitrifying agent increase, relative to that of water). In addition, the pH of the aqueous mixture increases with decreasing boric acid content and with increasing concentration of the vitrifying agent. Furthermore, the specific gravity of the aqueous mixture increases with increasing boric acid content. These properties of the aqueous mixture can have significant effect on its usefulness in many applications. For example, in many applications it may be useful avoid high viscosity in the aqueous mixture, such as where the mixture is applied to a substrate by spraying.

For most applications a high concentration of boric acid is desired. This is balanced against the need for complete dissolution of the boric acid and the other solution properties which are required for a given application, such as the viscosity, specific gravity and/or pH requirements of the aqueous mixture. At an AMP:boric acid molar ratio of about 0.3:1, an aqueous mixture containing 35% by weight boric acid provides a solution viscosity which is easy to handle and apply by spraying. At 57% by weight boric acid the aqueous 0.3:1 molar ratio mixture provides a much higher boric acid concentration, but also has a much higher viscosity, making it potentially difficult to spray. A 50% boric acid mixture is potentially ideal for spray applications as it has a moderate viscosity and fairly high boric acid content. All three concentrations (35, 50 and 57% boric acid) have moderate solution pH, between pH 7.5 and pH 8.0, and specific gravities between about 1.15 and 1.3. Therefore, an example of an embodiment of the invention is an aqueous composition comprising boric acid, AMP and water with an AMP:boric acid mole ratio of about 0.3:1 and boric acid concentration in the range of about 35% to 57% by weight. An example of such an embodiment which is ideal for spray applications could have a boric acid concentration of up to about 50% by weight.

At a boric:AMP acid mole ratio of 3:1 the boric acid solubility limit in the aqueous solution is approximately 33% by weight, but solutions up to 50% have good handling properties and show long-term stability if they are not subjected to extreme extensive temperature cycling.

The aqueous mixture of boric acid and a vitrifying agent may be applied to a substrate by any suitable method, such as spraying, dipping, brushing, or rolling, depending on the nature of the surface, the viscosity of the solution and other factors. It can be applied to a variety of materials, including cotton batting (e.g. for use in mattresses and furniture), cellulose insulation, paper, gypsum wallboard, wood, wood products, engineered wood, etc. to provide fire retardancy and/or biocidal protection. When applied to a surface and allowed to dry, the boric acid-amino alcohol mixture forms a non-crystalline boric acid-containing layer which can range in texture from sticky or soft to a hard glassy coating, depending on the choice of vitrifying agent. Since the vitrifying agent inhibits the formation of boric acid crystals, this layer can provide a uniform distribution of boric acid on a substrate which is readily adherent to the surface. In contrast to this, boric acid crystals or dust particles provide an inherently uneven distribution of boric acid which is more easily dislodged by physical contact.

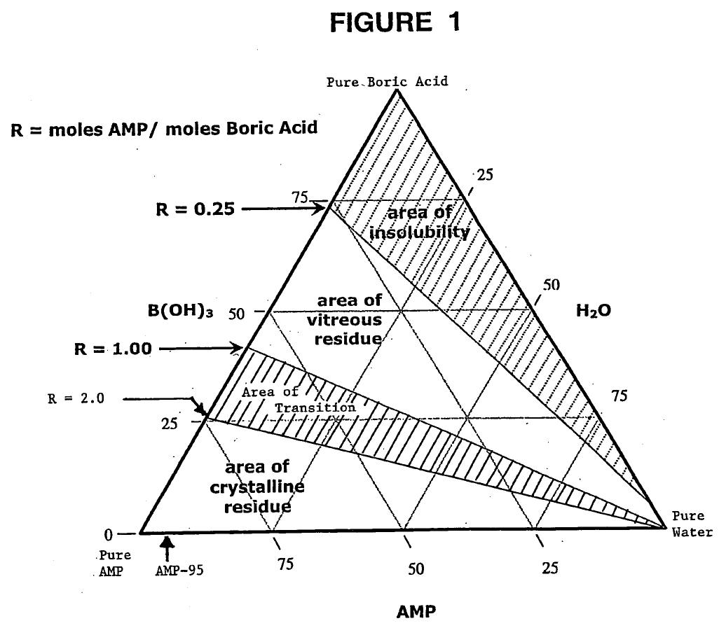

The molar ratio of the vitrifying agent to boric acid (i.e. the nitrogen to boron (N:B) molar ratio) is essential to the formation of a vitreous (non-crystalline) residue upon drying. Generally, if the vitrifying agent to boric acid molar ratio is less than about 0.2:1 then boric acid is not fully dissolved in the mixture, and if the molar ratio is greater than about 2:1 then a crystalline residue is formed upon drying of the aqueous mixture. However at a vitrifying agent to boric acid molar ratio above about 0.25:1 and below about 1:1 a vitreous (non-crystalline) residue is formed upon drying of the aqueous mixture. At molar ratios in the range of about 1:1 to 2:1 a transition zone occurs where limited crystallization may appear over an extended period of time. FIG. 1 illustrates the various composition zones for a mixture of boric acid, AMP and water.

In the case of non-hardening oily or tacky mixtures according to the invention, the non-crystalline boric acid residue can remain strongly adherent even to a surface which is somewhat flexible in nature. Such a boric acid coating or treatment can provide various beneficial properties to the treated material, including fire retardancy and biocidal protection. It can form a uniform surface layer or a penetrating treatment, depending on the porosity of the surface to which it is applied and can eliminate or reduce visual evidence of the treatment compared to treatments where boric acid is allowed to crystallize. When applied to paper or other absorbent cellulosic material, the boric acid treatment becomes virtually invisible upon drying.

The method of this invention may be used to apply a fire retardant non-crystalline boric acid treatment to cotton batting. For example, when an aqueous mixture of boric acid and AMP-95 is sprayed on the cotton batting and dried at 175° C. it provides improved fire resistance to the cotton. Furthermore, this non-crystalline boric acid treatment is more adherent to cotton batting than is boric acid which is applied as a powder or sprayed on as an aqueous solution and allowed to crystallize on the cotton fiber surfaces.

Treatment with boric acid according to the methods of this invention can provide biostatic and fire retardant treatments for a variety of products including wood, engineered wood, paper, cellulose insulation, and gypsum wall board. The benefits of inhibiting crystallization of boric acid include the formation of more adherent and uniform surface layers containing boric acid and reduction or elimination of visual evidence of treatment. These methods can also provide penetrating treatments for absorbent materials such as wood and other cellulosic products.

### EXAMPLES

The following examples illustrate the compositions and methods of this invention. The term “boric acid” as applied in these examples refers to orthoboric acid, H₃BO₃.

### Example 1

A series of aqueous mixtures were prepared by dissolving boric acid in AMP-95 and water. Each mixture was made up to a total weight of 100 grams, but the amounts of boric acid, AMP-95 and water were adjusted to provide different ratios of these three starting materials in each mixture. The composition of each mixture is shown in Table 1. Since AMP-95 is actually 5% water and 95% AMP, the 5% of water was accounted for in the water column in Table 1 and subtracted from the AMP column, so that the amounts listed are a true reflection of the amount of water and AMP in the samples.

TABLE 1

| | Wt boric | | | Wt % | AMP:BA |
|---|---|---|---|---|---|
| Expt No. | acid | Wt AMP | Wt Water | boric acid | mole ratio |
| 1 | 0.00 | 0.00 | 100.00 | 0.00 | NA |
| 2 | 50.00 | 25.00 | 25.00 | 50.00 | 0.35 |
| 3 | 25.00 | 25.00 | 50.00 | 25.00 | 0.69 |
| 4 | 0.00 | 25.00 | 75.00 | 0.00 | NA |
| 5 | 25.00 | 50.00 | 25.00 | 25.00 | 1.39 |
| 6 | 0.00 | 50.00 | 50.00 | 0.00 | NA |
| 7 | 0.00 | 75.00 | 25.00 | 0.00 | NA |
| 8a | 33.33 | 33.33 | 33.33 | 33.33 | 0.69 |
| 8b | 33.33 | 33.33 | 33.33 | 33.33 | 0.69 |
| 8c | 33.33 | 31.60 | 35.00 | 33.35 | 0.66 |
| 9 | 35.00 | 15.10 | 49.90 | 35.00 | 0.30 |
| 10 | 50.00 | 21.70 | 28.30 | 50.00 | 0.30 |
| 11 | 57.30 | 24.80 | 17.80 | 57.36 | 0.30 |
| 12 | 16.67 | 66.70 | 16.60 | 16.68 | 2.78 |
| 13 | 16.67 | 41.70 | 41.60 | 16.68 | 1.74 |
| 14 | 16.67 | 16.67 | 65.80 | 16.81 | 0.69 |
| 15 | 58.33 | 33.33 | 8.33 | 58.34 | 0.40 |
| 16 | 41.67 | 41.67 | 16.66 | 41.67 | 0.69 |
| 17 | 33.33 | 58.33 | 8.34 | 33.33 | 1.21 |
| 18 | 41.67 | 16.67 | 41.67 | 41.67 | 0.28 |
| 19 | 8.33 | 83.33 | 8.34 | 8.33 | 6.94 |
| 20 | 66.67 | 16.67 | 16.67 | 66.66 | 0.17 |
| 21 | 50.00 | 12.50 | 37.50 | 50.00 | 0.17 |
| 22 | 33.33 | 8.33 | 58.33 | 33.33 | 0.17 |
| 23 | 37.50 | 50.00 | 12.50 | 37.50 | 0.92 |
| 24 | 25.00 | 37.50 | 37.50 | 25.00 | 1.04 |
| 25 | 30.72 | 44.28 | 25.00 | 30.72 | 1.00 |
| 26 | 43.62 | 31.38 | 25.00 | 43.62 | 0.50 |

Approximately 2.0 grams of each solution was transferred to a watch glass and allowed to air dry at room temperature for eight days. Gravimetric analysis indicated that the water is removed on drying while the AMP is retained in the residue, along with the boric acid. After eight days of air drying, the condition of each of the air-dried solutions was characterized with respect to such features as crystallinity of the residue and the dryness and hardness of the residue. These results are listed in Table 2. The experimental results in Table 2 have been arranged in order of decreasing AMP:boric acid mole ratio.

TABLE 2

| Expt | Initial | Wt % | AMP:BA | Observation after 8 days |
|---|---|---|---|---|
| No. | soln pH | boric acid | mole ratio | of drying |
| 1 | 7.00 | 0.00 | NA | NA |
| 4 | 12.48 | 0.00 | NA | crystalline solid |
| 6 | 13.04 | 0.00 | NA | crystalline solid |
| 7 | 13.55 | 0.00 | NA | crystalline solid |
| 19 | 11.72 | 8.33 | 6.94 | crystalline solid |
| 12 | 11.33 | 16.68 | 2.78 | crystalline solid |
| 13 | 11.13 | 16.68 | 1.74 | little crystals have formed in |
| | | | | glassy solid |
| 5 | 11.02 | 25.00 | 1.39 | clear glassy solid with sticky |
| | | | | soft surface |
| 17 | 10.92 | 33.33 | 1.21 | mostly clear solid, patches of |
| | | | | white film on the surface |
| 24 | | 25.00 | 1.04 | clear glassy solid, somewhat |
| | | | | soft surface |
| 25 | | 30.72 | 1.00 | clear glassy solid, somewhat |
| | | | | soft surface |
| 23 | | 37.50 | 0.92 | mostly clear solid, some patches |
| | | | | of white film on surface |
| 14 | 10.03 | 16.81 | 0.69 | clear glassy solid, dry surface |
| 3 | 10.19 | 25.00 | 0.69 | clear glassy solid, dry surface |
| 8a | 10.27 | 33.33 | 0.69 | clear glassy solid, dry surface |
| 8b | 10.33 | 33.33 | 0.69 | clear glassy solid, dry surface |
| 16 | 10.43 | 41.67 | 0.69 | clear glassy solid, somewhat |
| | | | | soft surface |
| 8c | 10.32 | 33.35 | 0.66 | clear glassy solid, dry surface |
| 26 | | 43.62 | 0.50 | clear glassy solid, somewhat |
| | | | | soft surface |
| 15 | | 58.34 | 0.40 | clear glassy solid, somewhat |
| | | | | soft surface |
| 2 | 8.61 | 50.00 | 0.35 | clear glassy solid, dry surface |
| 9 | 7.99 | 35.00 | 0.30 | clear glassy solid, dry surface |
| 10 | 7.74 | 50.00 | 0.30 | clear glassy solid, dry surface |
| 11 | 7.66 | 57.36 | 0.30 | clear glassy solid, somewhat |
| | | | | soft surface |
| 18 | 7.72 | 41.67 | 0.28 | clear glassy solid, dry surface |
| 20 | | 66.66 | 0.17 | did not dissolve at room |
| | | | | temperature |
| 21 | | 50.00 | 0.17 | did not dissolve at room |
| | | | | temperature |
| 22 | | 33.33 | 0.17 | did not dissolve at room |
| | | | | temperature |

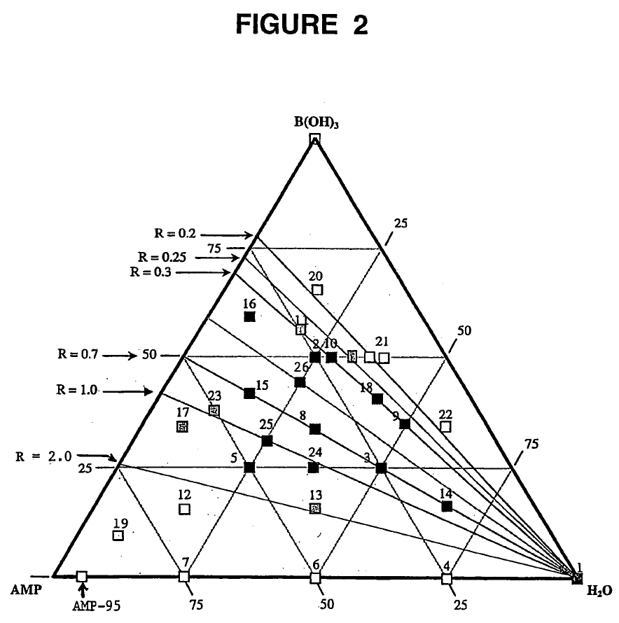

The results are shown graphically as data points in FIG. 2. FIG. 2 is a mixture diagram, showing pure boric acid at the top point and decreasing boric acid moving down the graph, pure AMP at the lower left corner and decreasing AMP moving across the diagram to the right and up toward the opposing side of the triangle on the upper right, and pure water at the lower right corner and decreasing water moving across the diagram to the left and up toward the opposing side of the triangle on the upper left. The experimental data points are identified in FIG. 2 by the experiment number, coinciding with the experiment numbers in Tables 1 and 2. Table 2 indicates which points yielded a crystalline solid residue, a clear glassy (vitreous) residue, a transitional residue, or boric acid not fully dissolved. The results shown in Table 2 and FIG. 2 confirm the various regions shown in the mixture diagram in FIG. 1.

### Example 2

A series of aqueous solutions were prepared containing 4% by weight boric acid (H₃BO₃) and varying amounts of 2-amino-2-methyl-1-propanol (“AMP”). AMP-95, a commercially available solution of 95% AMP in water) was used as the source of AMP. The test solutions were made by combining 1 gram of OPTIBOR® boric acid (manufactured by U.S. Borax Inc.) with the required amount of AMP-95 to give the desired mole ratio of AMP to boric acid, and sufficient deionized water to provide a 4% boric acid solution. The AMP:boric acid mole ratio in the test solutions ranged from 0.2:1 to 0.8:1 The solutions were mixed in a test tube by stirring with a glass rod until the boric acid was completely dissolved. Each solution was then poured into a watch glass and allowed to air dry at room temperature for a period of 34 days. The solution compositions are listed in Table 3 along with a description of the solution residue after evaporation.

TABLE 3

| Mole ratio | | | | Condition of solution |
|---|---|---|---|---|
| AMP-95:Boric | g Boric | | g DI | residue after evaporation |
| Acid | Acid | g AMP-95 | water | at room temperature |
| 0.2 | 1 | 0.28 | 23.72 | Crystals formed within |
| | | | | 13 days |
| 0.3 | 1 | 0.47 | 23.53 | Dried clear/no crystals |
| 0.4 | 1 | 0.56 | 23.44 | Dried clear/no crystals |
| 0.5 | 1 | 0.76 | 23.24 | Fine crystals at edges |
| | | | | after 34 days |
| 0.6 | 1 | 0.90 | 23.10 | Dried clear/no crystals |
| 0.7 | 1 | 1.05 | 22.95 | Dried clear/no crystals |
| 0.8 | 1 | 1.20 | 22.80 | Dried clear/no crystals |

Examination of the solution residues after 13 days of air drying indicated that boric acid had crystallized out of the solution containing an AMP:boric acid mole ratio of 0.2:1. However, all of the other solutions (containing mole ratios of between 0.3:1 and 0.8:1) remained clear with no crystallization of boric acid.

After 34 days of air drying, crystals were observed around the edges of the 0.5:1 ratio solution, while the solutions at mole ratios of 0.4, 0.6, 0.7 and 0.8:1 remained clear and non-crystalline.

### Example 3

A series of aqueous solutions similar to Example 2 was prepared, containing 4% by weight boric acid (H₃BO₃) and varying amounts of tris(hydroxylmethyl)aminomethane (“TRIS”). The TRIS:boric acid mole ratio in these solutions ranged from 0.2:1 to 2.0:1 Each solution was then poured into a watch glass and allowed to air dry at room temperature for a period of 13 days. The solution compositions are listed in Table 4 along with a description of the solution residue after evaporation.

TABLE 4

| Mole ratio | | | | Condition of solution residue |
|---|---|---|---|---|
| TRIS:Boric | g Boric | | g DI | after 13 days evaporation at |
| Acid | Acid | g TRIS | water | room temperature |
| 0.2 | 1 | 0.39 | 23.61 | Crystals formed |
| 0.25 | 1 | 0.46 | 23.54 | Crystals formed |
| 0.5 | 1 | 0.97 | 23.03 | Dried clear/no crystals |
| 1.0 | 1 | 1.94 | 22.06 | Crystals formed |
| 1.5 | 1 | 2.91 | 21.09 | Crystals formed |
| 2.0 | 1 | 3.88 | 20.12 | Crystals formed |

After 13 days of air drying, crystallization of boric acid was observed at low mole ratios TRIS:boric acid, i.e. 0.2:1 and 0.25:1, and at high mole ratios of 1.0:1, 1.5:1 and 2.0:1. The only solution which did not crystallize upon drying was at the intermediate concentration of 0.5:1.

### Example 4

A series of aqueous solutions similar to Example 2 was prepared, using 5-amino-1-pentanol as the vitrifying agent. Each solution was poured into a watch glass and allowed to air dry at room temperature for a period of 15 days. The mole ratio of 5-amino-1-pentanol to boric acid in each of the solutions is listed in Table 5 along with a description of the solution residue after drying.

TABLE 5

| | Condition of solution residue |
|---|---|
| Mole ratio | after 15 days evaporation at |
| 5-amino-1-pentanol:Boric Acid | room temperature |
| 0.2 | Crystals formed |
| 0.25 | No crystals/sticky & fluid |
| 0.5 | No crystals/sticky & fluid |
| 1.0 | No crystals/sticky & fluid |
| 1.5 | No crystals/sticky & fluid |
| 2.0 | No crystals/sticky & fluid |

After 15 days of air drying, crystallization of boric acid was observed only at the lowest ratio of 5-amino-1-pentanol to boric acid, i.e. at 0.2:1. The higher mole ratios, i.e. from 0.25:1 up to 2:1, all yielded a clear sticky fluid without crystals.

### Example 5

A series of aqueous solutions similar to Example 4 was prepared, using lysine, an amino acid, as the vitrifying agent. Each solution was poured into a watch glass and allowed to air dry at room temperature for a period of 15 days. The mole ratio of lysine to boric acid in each of the solutions is listed in Table 6 along with a description of the solution residue after drying.

TABLE 6

| | Condition of solution residue |
|---|---|
| Mole ratio | after 15 days evaporation at |
| Lysine:Boric Acid | room temperature |
| 0.2 | Crystals formed |
| 0.25 | Crystals formed |
| 0.5 | No crystals/yellow |
| | transparent sticky fluid |
| 1.0 | Cloudy |
| 1.5 | Crystals formed |
| 2.0 | Crystals formed |

After 15 days of drying at room temperature, the 0.5:1 mole ratio of lysine to boric acid dried to a sticky, transparent yellowish residue, which was free of crystals. The 1.0:1 mole ratio solution yielded a cloudy yellow residue. All other residues resulted in the formation of obvious crystals.

### Example 6

### Comparative

A series of aqueous solutions similar to Example 4 was prepared, using AMP-95, as the vitrifying agent, but using borax (Na₂B₄O₇.10H₂O) in place of boric acid. Each solution was poured into a watch glass and allowed to air dry at room temperature for a period of 15 days. The mole ratio of AMP-95 to borax in each of the solutions is listed in Table 7 along with a description of the solution residue after drying.

TABLE 7

| | Condition of solution residue |
|---|---|
| Mole ratio | after 15 days evaporation at |
| AMP-95:Borax | room temperature |
| 0.2 | Crystals formed |
| 0.25 | Crystals formed |
| 0.5 | Crystals formed |
| 1.0 | Crystals formed |
| 1.5 | Crystals formed |
| 2.0 | Crystals formed |

At all ratios of AMP-95 to borax, crystals were formed within a couple of days. This illustrates that borax cannot be substituted for boric acid in the methods of this invention, as a vitreous residue is not obtained.

### Example 7

A second series of aqueous solutions similar to Example 2 was prepared, using AMP-95, as the vitrifying agent in combination with boric acid. Each solution was poured into a watch glass and allowed to air dry at room temperature for an extended period of several months. The mole ratio of AMP to boric acid in each of the solutions is listed in Table 8 along with a description of the solution residue at various stages drying.

TABLE 8

| Mole ratio | | |
|---|---|---|
| AMP-95:Boric | Observations | |
| Acid | up to 28 days | Observations after 55 days |
| 0.1 | Crystallized within | |
| | 1 day | |
| 0.2 | Crystallized within | |
| | 1 day | |
| 0.3 | Crystallized after | |
| | 4-5 days | |
| 0.4 | Hard solid; crystals | Very little crystal formation; |
| | after 28 days | clear, non-sticky, with small |
| | | cracks |
| 0.5 | Hard, cloudy solid | Hard, clear, non-sticky surface |
| | after 28 days | with small cracks |
| 0.6 | Hard, clear solid | Hard, clear, wrinkled, non- |
| | after 28 days | sticky film |
| 0.7 | Hard, clear solid | Hard, clear, wrinkled, non- |
| | after 28 days | sticky film |
| 0.8 | Hard, clear solid | Hard, clear, non-sticky surface |
| | after 28 days | with very sporadic crystals |
| 0.9 | Hard, mostly clear | Hard, clear, non-sticky surface |
| | solid after 28 days | with very sporadic crystals |
| 1.0 | Hard, mostly clear | Hard, clear, non-sticky surface |
| | solid after 28 days | with very sporadic crystals |
| 1.5 | Crystallized within | |
| | 1 day | |
| 2.0 | Crystallized within | |
| | 1 day | |
| 2.5 | Crystallized within | |
| | 1 day | |
| 3.0 | Crystallized within | |
| | 1 day | |

After only one day boric acid crystallized out of solution at the low mole ratios of AMP to boric acid (i.e. 0.1:1 and 0.2:1) and at the high mole ratios (i.e. 1.5, 2.0, 2.5 and 3.0:1), while at the intermediate ratios (between 0.3:1 and 1.0:1) the drying solution residues remained clear. After 4 to 5 days the and 0.3:1 ratio had also crystallized. After 4 weeks the 0.4:1 mole ratio had also crystallized and the 0.5:1 ratio had developed a hard, cloudy solid, while the 0.6:1 to 0.8:1 ratios remained clear and the 0.9:1 and 1.0:1 ratios remained mostly clear. Even after 55 days there was at most only minimal formation of crystals at the ratios between 0.3:1 and 1:1, and no crystals observed in the range of 0.5:1 to 0.7:1.

### Example 8

A series of aqueous solutions similar to Example 7 was prepared, using diethanolamine (DEA) as the vitrifying agent. Each solution was poured into a watch glass and allowed to air dry at room temperature for an extended period of several months. The mole ratio of DEA to boric acid in each of the solutions is listed in Table 9 along with a description of the solution residue at various stages drying.

TABLE 9

| Mole ratio | | |
|---|---|---|
| DEA:Boric | Observations | |
| Acid | up to 28 days | Observations after 55 days |
| 0.1 | Crystallized | |
| | within 1 day | |
| 0.2 | Crystallized | |
| | within 1 day | |
| 0.3 | Soft, clear | Hard, clear, wrinkled, non-sticky film |
| 0.4 | Soft, clear | Hard, clear, wrinkled, non-sticky film |
| 0.5 | Hard, clear | Hard, clear, wrinkled, non-sticky film |
| 0.6 | Hard, clear | Hard, clear, slightly sticky film |
| 0.7 | Hard, clear | Hard, clear, slightly sticky film |
| 0.8 | Tacky | Semi-hard, clear film, more sticky |
| | | than at 0.6 and 0.7 ratios |
| 0.9 | Tacky | Not hard/not fluid, clear film, more |
| | | sticky than at 0.8 ratio |
| 1.0 | Tacky | Not hard/not fluid, clear film, more |
| | | sticky than at 0.8 ratio |
| 1.5 | Tacky liquid | Clear, sticky, very viscous |
| 2.0 | Tacky liquid | Clear, sticky, very viscous |
| 2.5 | Tacky liquid | Clear, fairly fluid, no crystals |
| 3.0 | Tacky liquid | Clear, fairly fluid, no crystals |

As in Example 6, boric acid crystallized out of solution at the low mole ratios of DEA to boric acid (i.e. 0.1:1 and 0.2:1) after only one day of drying. However, no crystallization was observed at the high mole ratios. All solutions at mole ratios from 0.3:1 up to 3:1 remained clear, with no crystallization observed, even after 55 days. At the mole high ratios, above 1:1, the solutions remained at least somewhat fluid even after 55 days, while the solution residues hardened over time at the lower ratios, particularly in the range of 0.3:1 to 0.7:1.

### Example 9

A series of tests was conducted to evaluate the effectiveness of the method of this invention, compared with the use of boric acid alone, for treating cotton and paper to improve fire retardancy. Samples of cotton and paper were either (a) treated with an aqueous solution of boric acid (H₃BO₃) and AMP-95 (at 5% by weight boric acid), (b) treated with an aqueous solution of boric acid alone (at 5% by weight boric acid); or (c) untreated. Samples of cotton were obtained by cutting square pieces of cotton measuring roughly 2.5 inches by 2.5 inches from a ½ inch thick sheet of sterile absorbent cotton from Johnson & Johnson. 90-mm diameter circles of Whatman No. 41 (ashless) filter paper were used as the paper samples. The samples of cotton and paper were sprayed with either solution (a) or solution (b), then dried overnight at room temperature. After drying overnight, the treated samples heated in an oven at 105° C. for 25-30 minutes to eliminate any remaining surface moisture. The samples were then exposed to an open flame and the extent and rate of burning were observed visually. The results of the flame tests are described below.

The untreated cotton sample burned at a fairly fast rate and disintegrated (turned to ash). The boric acid-treated cotton sample burned at a moderate rate (slower than the untreated sample), burning to a black char. The cotton sample which had been treated with AMP and boric acid burned at an even slower rate that the samples treated with boric acid alone, and did not burn completely. A black char was formed at the bottom where the sample was ignited, while the sample turned yellow on the parts above the ignition point.

The untreated paper sample burned completely and disintegrated. The boric acid-treated paper sample charred completely but did not disintegrate. The paper sample which had been treated with AMP and boric acid burned at an even slower rate that the samples treated with boric acid alone, and did not completely burn—it charred ¾ of the way up and then the flame went out.

### Example 10

A series of tests was run to evaluate whether the amino alcohol solutions of the invention would produce an unacceptable odor upon heating to a high temperature as is sometimes required in the treatment of cotton batting. 10% solutions of boric acid containing either monoethanolamine (MEA) or AMP-95 at an amino alcohol:boric acid mole ratio of 0.5:1 were made and sprayed on cotton samples, as in Example 9. The weight of the untreated, treated (wet) and treated (dried) cotton samples are provided in Table 10. The treated samples were heated in an oven at a temperature of 175° C. for approximately 35 minutes for the AMP-95/boric acid-treated samples and 35-40 minutes for the MEA/boric acid-treated samples.

TABLE 10

| | | | Sample Weight (grams) | | | |
|---|---|---|---|---|---|---|
| Sample | | Treatment | | Treated | Treated | |
| No. | Sample | Solution* | Untreated | (wet) | (dry) | Results |
| 1 | Cotton | BA/AMP-95 | 0.84 | 2.55 | ~0.90 | Only very faint odor, slightly |
| | | | | | | yellowed, slightly fluffed |
| 2 | Cotton | BA/AMP-95 | 0.85 | 2.36 | ~0.93 | Only very faint odor, slightly |
| | | | | | | yellowed, slightly fluffed |
| 3 | Cotton | BA/AMP-95 | 0.88 | 2.55 | ~0.98 | Only very faint odor, slightly |
| | | | | | | yellowed, slightly fluffed |
| 4 | Cotton | BA/AMP-95 | 0.86 | 2.45 | ~0.91 | Only very faint odor, slightly |
| | | | | | | yellowed, slightly fluffed |
| 5 | Cotton | BA/MEA | 0.90 | 2.40 | ~0.93 | Only very faint odor, |
| | | | | | | moderately yellowed |
| 6 | Cotton | BA/MEA | 1.01 | 2.06 | ~1.05 | Only very faint odor, |
| | | | | | | moderately yellowed |
| 7 | Cotton | BA/MEA | 0.99 | 2.23 | ~1.01 | Only very faint odor, |
| | | | | | | moderately yellowed |
| 8 | Cotton | BA/MEA | 0.98 | 1.95 | ~0.99 | Only very faint odor, |
| | | | | | | moderately yellowed |

*BA = Boric Acid; AMP-95 = 95% 2-amino-2-methyl-1-propanol; MEA = monoethanolamine

During heating in the oven, only a very faint odor was produced and no amine odor was detected with either AMP-95 or MEA. The cotton became slightly yellowed with the BA/AMP-95 combination and moderately yellowed with the BA/MEA combination. Samples were slightly fluffed (increased in volume) after heating with the BA/AMP-95 combination.

Aspects of the subject matter described herein are set out in the following clauses.

A method is provided for forming a vitreous boric acid-containing coating on a substrate comprising the steps of: (a) dissolving a source of boric acid in water and a vitrifying agent selected from the group consisting of amino alcohols and amino acids to form an aqueous mixture; (b) applying the aqueous mixture to the substrate to form a coating; and (c) allowing the coating to dry.

A method is provided for use of a vitrifying agent to prevent the crystallization of boric acid from a boric acid-containing aqueous mixture upon drying of the mixture, wherein the vitrifying agent is selected from the group consisting of amino alcohols and amino acids.

A method is provided for use of a vitrifying agent to obtain a vitreous boric acid-containing residue from an aqueous boric acid-containing mixture upon drying of the mixture, wherein the vitrifying agent is selected from the group consisting of amino alcohols and amino acids.

An aqueous composition comprising boric acid, a vitrifying agent and water wherein the vitrifying agent is selected from the group consisting of 2-amino-2-methyl-1-propanol, tris(hydroxylmethyl)aminomethane, 5-aminopentanol, and lysine and the mole ratio of the vitrifying agent to boric acid is above about 0.25:1 and below about 1:1.

A fire retardant article comprising a combustible material and further comprising a vitreous boric acid-containing residue.

An article comprising wood or lignocellulosic-based material and further comprising a vitreous boric acid-containing residue.

Various changes and modifications of the invention can be made and to the extent that such changes and modifications incorporate the spirit of this invention, they are intended to be included within the scope of the appended claims.

What is claimed is:

1. A method for inhibiting the crystallization of boric acid comprising the steps of dissolving a source of boric acid in water and a vitrifying agent selected from the group consisting of amino alcohols and amino acids to form an aqueous mixture and allowing the aqueous mixture to dry, thereby forming a vitreous boric acid-containing residue.

2. The method of claim 1 wherein the mole ratio of the vitrifying agent to boric acid is above about 0.25:1 and below about 1:1 and wherein the aqueous mixture is applied to a surface of a substrate before it is allowed to dry, thereby forming a vitreous boric acid-containing residue on and/or in the substrate.

3. The method of claim 1 wherein the mole ratio of the vitrifying agent to boric acid is in the range of from about 0.3:1 to about 1:1.

4. The method of claim 1 wherein the vitrifying agent is selected from the group consisting of 2-amino-2-methyl-1-propanol, ethanolamine, tris(hydroxylmethyl)aminomethane, 5-aminopentanol, and lysine.

5. The method of claim 1 wherein the boric acid-containing residue is a solid.

6. The method of claim 1 wherein the boric acid-containing residue is a viscous fluid.

7. The method according to claim 1 wherein the aqueous mixture is applied to cotton batting, wood, wood products, engineered wood, paper, cellulose insulation or gypsum wallboard.

8. The method according to claim 2 wherein the vitreous boric acid-containing residue forms a coating on the surface of the substrate.

9. The method according to claim 8 wherein the coating is a hard vitreous boric acid-containing layer.

10. The method according to claim 8 wherein the coating is a tacky vitreous boric acid-containing layer.

11. The method according to claim 2 wherein the aqueous mixture penetrates into the substrate and dries within the substrate, thereby depositing a vitreous boric acid-containing residue within the substrate.

12. A method for protecting a combustible material against fire comprising the steps of: (a) dissolving a source of boric acid in water and a vitrifying agent selected from the group consisting of amino alcohols and amino acids to form an aqueous mixture; (b) applying the aqueous mixture to a surface of the combustible material; and (c) allowing the aqueous mixture to dry such that a vitreous boric acid-containing residue is deposited on the surface of the combustible material and/or within the combustible material, thereby enhancing the fire retardant nature of the combustible material.

13. The method according to claim 12 wherein the combustible material is cotton batting.

14. The method according to claim 13 wherein the cotton batting is heated after the aqueous mixture is applied.

15. A fire retardant article comprising a combustible material and further comprising a vitreous boric acid-containing residue, prepared according to the method of claim 12.

16. A method for protecting wood or lignocellulosic-based products against decay and insect attack comprising the steps of: (a) dissolving a source of boric acid in water and a vitrifying agent selected from the group consisting of amino alcohols and amino acids to form an aqueous mixture; (b) applying the aqueous mixture to the wood or lignocellulosic-based product; (c) allowing the aqueous mixture to penetrate into the wood or lignocellulosic-based product; and (d) allowing the aqueous mixture to dry within the substrate, depositing a vitreous boric acid-containing residue, thereby providing protection against decay and insect attack.

17. An article comprising wood or lignocellulosic-based material and further comprising a vitreous boric acid-containing residue, prepared according to the method of claim 16.

18. The composition according to claim 21 wherein the vitrifying agent is 2-amino-2-methyl-1-propanol.

19. The composition of claim 18 wherein the concentration of boric acid is in the range of about 35% to 57% by weight.

20. The composition of claim 19 wherein the mole ratio of 2-amino-2-methyl-1-propanol to boric acid is at least about 0.3:1 and the concentration of boric acid is up to about 50% by weight.

21. An aqueous composition comprising boric acid, a vitrifying agent and water wherein the vitrifying agent is selected from the group consisting of 2-amino-2-methyl-1-propanol, tris(hydroxylmethyl)aminomethane, 5-aminopentanol, and lysine and the mole ratio of the vitrifying agent to boric acid is above about 0.25:1 and below about 1:1.

22-23. (canceled)
